(19) United States
(12) Patent Application Publication
(10) Pub. No.: US 2003/0215669 A1
(43) Pub. Date: Nov. 20, 2003

(54) Electroluminescent device

(75) Inventors: Poopathy Kathirgamanathan, North Harrow (GB); Selvadurai Selvaranjan, Surrey (GB)

Correspondence Address: Dr. Marta E. Delsignore, PhD, Goodwin Procter L.L.P., 599 Lexington Avenue, New York, NY, 10022, US

(73) Assignee: Elam-T Limited

(21) Appl. No.: 10/442,674

(22) Filed: May 20, 2003

Related U.S. Application Data
(63) Continuation of application No. PCT/GB01/05113, filed on Nov. 21, 2001.

(30) Foreign Application Priority Data
Nov. 21, 2000 (GB) 0028436.4

(51) Int. Cl. H05B 33/12

(52) U.S. Cl. 428/690; 428/917; 313/504; 313/506; 257/40

(57) ABSTRACT

An electroluminescent device has a conjugated polymer as a layer of a hole transmitting material which is a conjugated polymer.

The present invention relates to electroluminescent devices.

Materials which emit light when an electric current is passed through them are well known and used in a wide range of display applications. Liquid crystal devices and devices which are based on inorganic semiconductor systems are widely used, however these suffer from the disadvantages of high energy consumption, high cost of manufacture, low quantum efficiency and the inability to make flat panel displays.

Organic polymers have been proposed as useful in electroluminescent devices, but it is not possible to obtain pure colours, they are expensive to make and have a relatively low efficiency.

Another compound which has been proposed is aluminium quinolate, but this requires dopants to be used to obtain a range of colours and has a relatively low efficiency.

Patent application WO98/58037 describes a range of lanthanide complexes which can be used in electroluminescent devices which have improved properties and give better results. Patent Applications PCT/GB98/01773, PCT/GB99/03619, PCT/GB99/04030, PCT/GB99/04024, PCT/GB99/04028, PCT/GB00/00268 describe electroluminescent complexes, structures and devices using rare earth chelates.

U.S. Pat. No. 5,128,587 discloses an elcctroluminescent device which consists of an organometallic complex of rare earth elements of the lanthanide series sandwiched between a transparent electrode of high work function and a second electrode of low work function with a hole conducting layer interposed between the electroluminescent layer and the transparent high work function electrode and an electron conducting layer interposed between the electroluminescent layer and the electron injecting low work function anode. The hole conducting layer and the electron conducting layer are required to improve the working and the efficiency of the device. The hole transporting layer serves to transport holes and to block the electrons, thus preventing electrons from moving into the electrode without recombining with holes. The recombination of carriers therefore mainly takes place in the emitter layer.

We have now devised electroluminescent devices with an improved hole transporting layer which is a conjugated polymer.

U.S. Pat. No. 5,807,627 discloses an electroluminescence device in which there are conjugated polymers in the electroluminescent layer. The conjugated polymers referred to are defined as polymers for which the main chain is either fully conjugated possessing extended pi molecular orbitals along the length of the chain or else is substantially conjugated, but with interruptions to conjugation, either random or regular along the main chain. They can be homopolymers or copolymers.

According to the invention there is provided an electroluminescent device comprising (i) a first electrode, (ii) a hole transporting layer formed of a conjugated polymer, (iii) a layer consisting of an electroluminescent material and (iv) a second electrode.

The conjugated polymer used can be any of the conjugated polymers disclosed or referred to in U.S. Pat. No. 5,807,627, PCT/WO90/13148 and PCT/WO92103490.

The preferred conjugated polymers are poly (p-phenylenevinylene)-PPV and copolymers including PPV. Other preferred polymers are poly(2,5 dialkoxyphenylene vinylene) such as poly (2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, ploythiophenes and oligothiophenes.

In PPV the phenylene ring may optionally carry one or more substituents e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as an anthracene or naphthlyene ring and the number of vinylene groups in each polyphenylenevinylene moiety can be increased e.g. up to 7 or higher.

The conjugated polymers can be made by the methods disclosed in U.S. Pat. No. 5,807,627, PCT/WO90/13148 and PCT/WO92/03490.

The thickness of the hole transporting layer is preferably 20 nm to 200 nm.

The conjugated polymer can be deposited on the substrate from a solution in a suitable solvent.

Optionally there can be an electron injecting layer between the electroluminescent layer and the second electrode.

Rare earth chelates are known which fluoresce in ultra violet radiation and A. P. Sinha (Spectroscopy of Inorganic Chemistry Vol. 2 Academic Press 1971) describes several classes of rare earth chelates with various monodentate and bidentate ligands.

Group III A metals and lanthanides and actinides with aromatic complexing agents have been described by G. Kallistratos (Chimica Chronika, New Series, 11, 249-266 (1982)). This reference specifically discloses the Eu(III), Tb(III), U(III) and U(IV) complexes of diphenyl-phosponamidotriphenyl-phosphoran.

EP 0744451A1 also discloses fluorescent chelates of transition or lanthanide or actinide metals and the known chelates which can be used are those disclosed in the above references including those based on diketone and triketone moieties.

Any metal ion having an unfilled inner shell can be used as the metal and the preferred metals are selected from Sm(III), Eu(II), Eu(III), Tb(III), Dy(III), Yb(III), Lu(III), Gd(III), Gd(III) U(III), Tm(III), Ce(III), Pr(III), Nd(III), Pm(III), Dy(III), Ho(III), and Er(III).

The electroluminescent compounds which can be used in the present invention are of general formula (Lα)ₙM where M is a rare earth, lanthanide or an actinide, Lα is an organic complex and n is the valence state of M.

Preferred electroluminescent compounds which can be used in the present invention are of formula

(Lα)ₙ>M←Lp

where Lα and Lp are organic ligands, M is a rare earth, transition metal, lanthanide or an actinide and n is the valence state of the metal M. The ligands Lα can be the same or different and there can be a plurality of ligands Lp which can be the same or different.

For example (L₁)(L₂)(L₃)(L . . . )M (Lp) where M is a rare earth, transition metal, lanthanide or an actinide and (L₁)(L₂)(L₃)(L . . . ) are the same or different organic complexes and (Lp) is a neutral ligand. The total charge of the ligands (L₁)(L₂)(L₃)(L . . . ) is equal to the valence state of the metal M. Where there are 3 groups Lα which corresponds to the III valence state of M the complex has the formula (L₁)(L₂)(L₃)M (Lp) and the different groups (L₁)(L₂)(L₃) may be the same or different

Lp can be monodentate, bidentate or polydentate and there can be one or more ligands Lp.

Preferably M is metal ion having an unfilled inner shell and the preferred metals are selected from Sm(III), Eu(II), Eu(III), Tb(III), Dy(III), Yb(III), Lu(III), Gd(III), Gd(III) U(III), Tm(III), Ce(III), Pr(III), Nd(III), Pm(III), Dy(III), Ho(III), Er(III) and more preferably Eu(III), Tb(III), Dy(III), Gd(III).

Further electroluminescent compounds which can be used in the present invention are of general formula (Lα)ₙM₁M₂ where M₁ is the same as M above, M₂ is a non rare earth metal, Lα is a as above and n is the combined valence state of M₁ and M₂. The complex can also comprise one or more neutral ligands Lp so the complex has the general formula (Lα)ₙM₁M₂ (Lp), where Lp is as above. The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium, titanium, vanadium, zirconium, tantulum, molybdenum, rhodium, iridium, titanium, niobium, scandium, yttrium.

For example (L₁)(L₂)(L₃)(L . . . )M (Lp) where M is a rare earth, transition metal, lanthanide or an actinide and (L₁)(L₂)(L₃)(L . . . ) and (Lp) are the same or different organic complexes.

Further organometallic complexes which can be used in the present invention are binuclear, trinuclear and polynuclear organometallic complexes e.g. of formula

(Lm)ₓM₁←M₂(Ln)_{y} e.g.

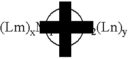

where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂.

In these complexes there can be a metal to metal bond or there can be one or more bridging ligands between M₁ and M₂ and the groups Lm and Ln can be the same or different.

By trinuclear is meant there are three rare earth metals joined by a metal to metal bond i.e. of formula

(Lm)ₓM₁-M₃(Ln)_{y}-M₂(Lp)_{z}

or

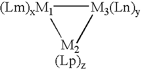

where M₁, M₂ and M₃ are the same or different rare earth metals and Lm, Ln and Lp are organic ligands Lα and x is the valence state of M₁, y is the valence state of M₂ and z is the valence state of M₃. Lp can be the same as Lm and Ln or different.

The rare earth metals and the non rare earth metals can be joined together by a metal to metal bond and/or via an intermediate bridging atom, ligand or molecular group.

For example the metals can be linked by bridging ligands e.g.

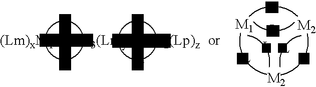

where L is a bridging ligand.

By polynuclear is meant there are more than three metals joined by metal to metal bonds and/or via intermediate ligands

M₁-M₂-M₃-M₄

or

M₁-M₂-M₄-M₃

or

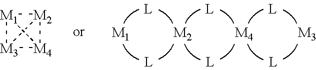

where M₁, M₂, M₃ and M₄ are rare earth metals and L is a bridging ligand.

The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper, silver, gold, zinc, cadmium, boron, aluminium, gallium, indium, germanium, tin, antimony, lead, and metals of the first, second and third groups of transition metals e.g. manganese, iron, ruthenium, osmium, cobalt, nickel, palladium, platinum, cadmium, chromium, titanium, vanadium, zirconium, tantulum, molybdenum, rhodium, iridium, titanium, niobium, scandium, yttrium etc.

Preferably Lα is selected from β diketones such as those of formulae

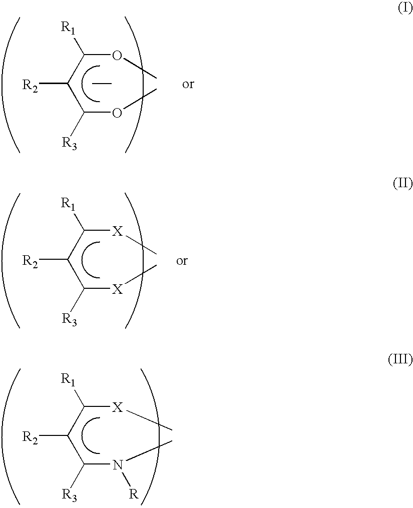

where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Some of the different groups Lα may also be the same or different charged groups such as carboxylate groups so that the group L₁ can be as defined above and the groups L₂, L₃ . . . can be charged groups such as

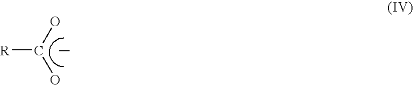

where R is R₁ as defined above or the groups L₁, L₂ can be as defined above and L₃ . . . etc. are other charged groups.

R₁, R₂ and R₃ can also be

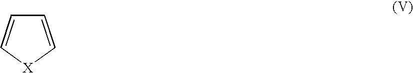

where X is O, S, Se or NH.

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltifiuoroacetone, 1-naphthoyltrifluoroacetone, 2-naphthoyltrifluoroacetone, 2-phenathoyltrifluoroacetone, 3-phenanthoyltrifluoroacetone, 9-anthroyltrifluoroacetonetrifluoroacetone, cinnamoyltrifluoroacetone, and 2-thenoyltrifluoroacetone.

The different groups La may be the same or different ligands of formulae

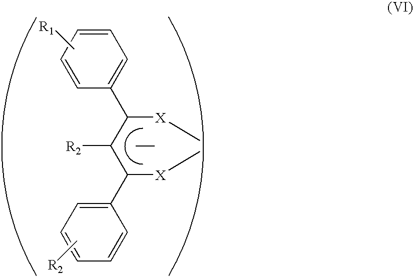

where X is O, S, or Se and R₁R₂ and R₃ are as above.

The different groups Lα may be the same or different quinolate derivatives such as

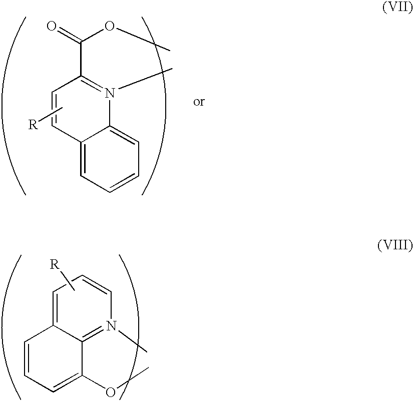

where R is hydrocarbyl, aliphatic, aromatic or heterocyclic carboxy, aryloxy, hydroxy or alkoxy e.g. the 8 hydroxy quinolate derivatives or

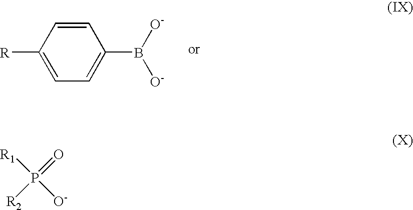

where R, R₁, and R₂ are as above or are H or F e.g. R₁ and R₂ are alkyl or alkoxy groups

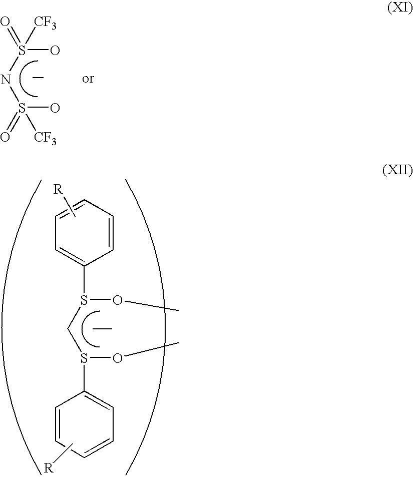

As stated above the different groups Lα may also be the same or different carboxylate groups e.g.

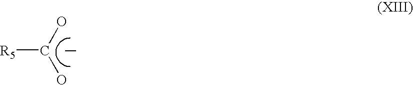

where R₅ is a substituted or unsubstituted aromatic, polycyclic or heterocyclic ring a polypyridyl group, R₅ can also be a 2-ethyl hexyl group so Lₙ is 2-ethylhexanoate or R₅ can be a chair structure so that Lₙ is 2-acetyl cyclohexanoate or Lα can be

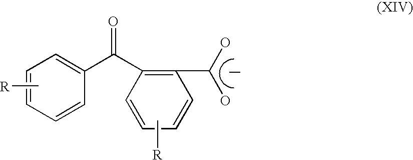

where R is as above e.g. alkyl, allenyl, amino or a fused ring such as a cyclic or polycyclic ring.

The different groups Lα may also be

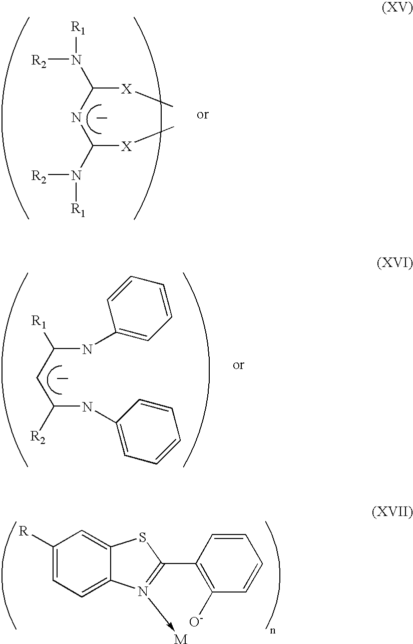

Where R, R₁ and R₂ are as above.

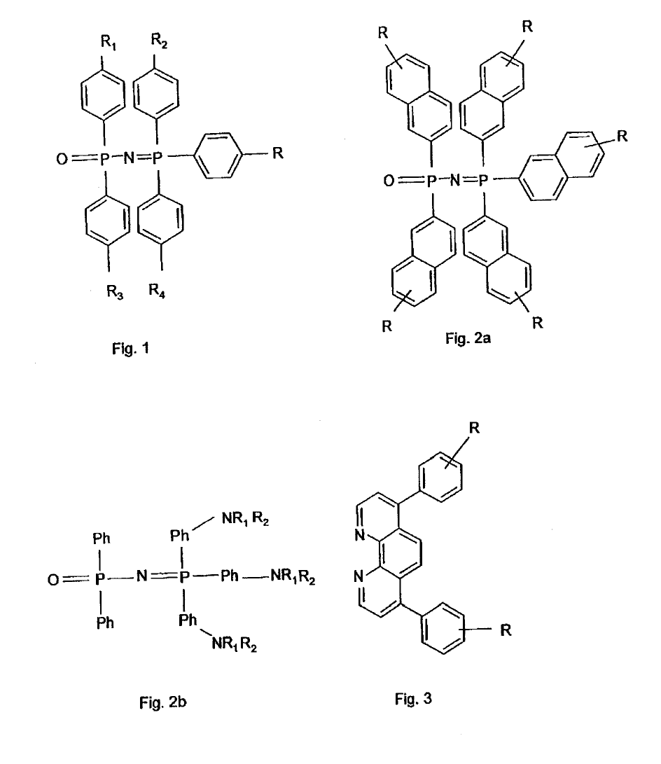

The groups Lₚ can be selected from

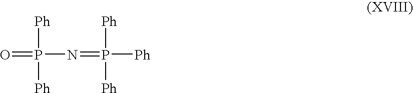

Where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene or pyrene group. The substituents can be for example an alkyl, aralkyl, alkoxy, aromatic, heterocyclic, polycyclic group, halogen such as fluorine, cyano, amino. Substituted amino etc. Examples are given in FIGS. 1 and 2 of the drawings where R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups

—C—CH₂═CH₂—R

where R is as above.

Lₚ can also be compounds of formulae

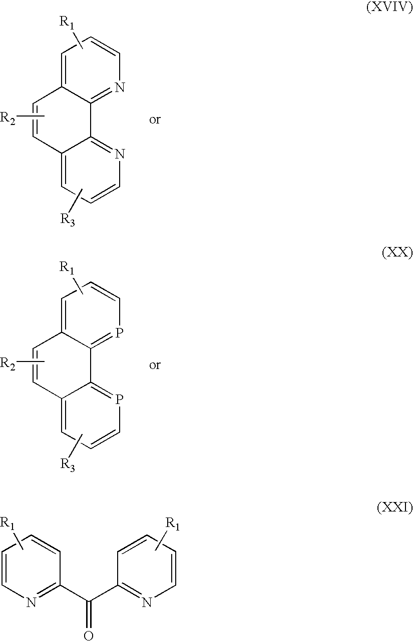

where R₁, R₂ and R₃ are as referred to above, for example bathophen shown in FIG. 3 of the drawings in which R is as above or

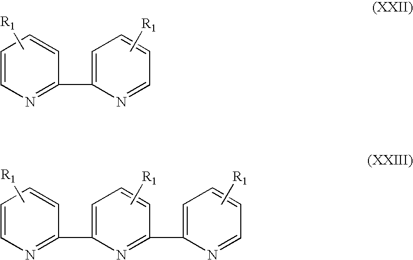

where R₁, R₂ and R₃ are as referred to above.

Lₚ can also be

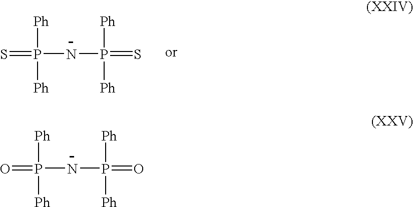

where Ph is as above.

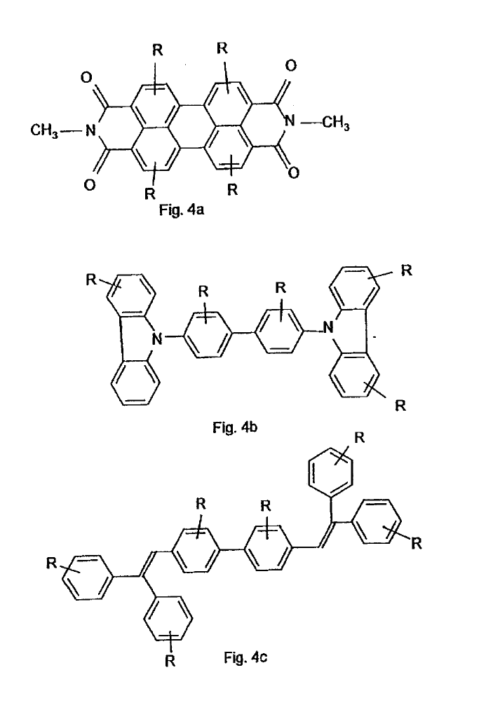

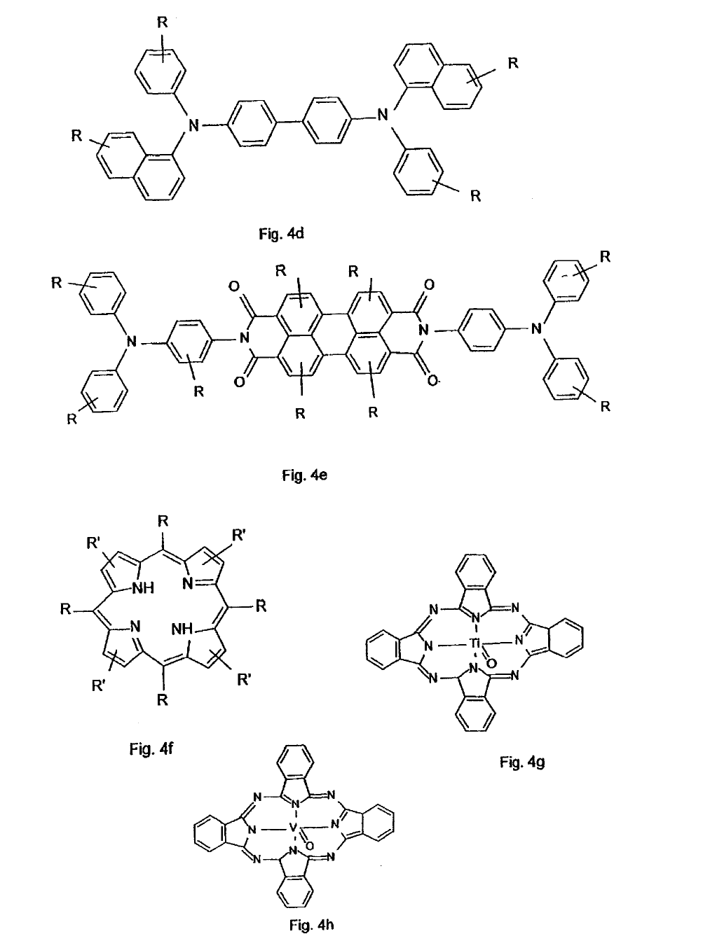

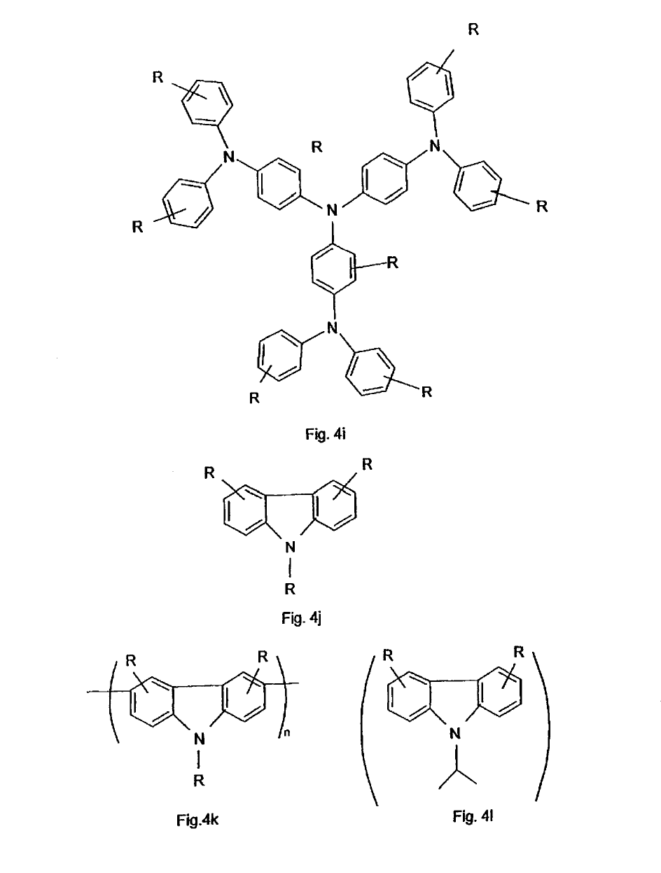

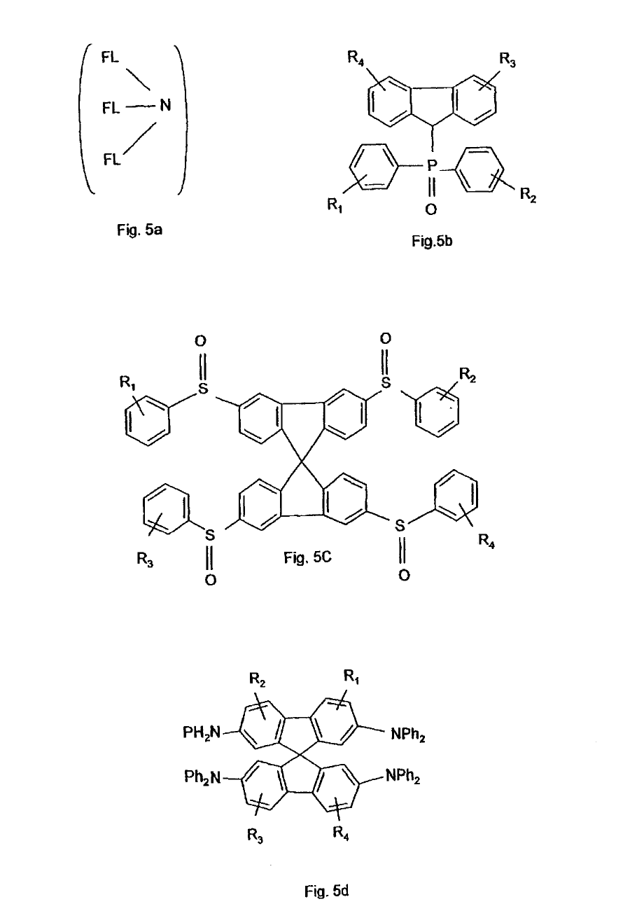

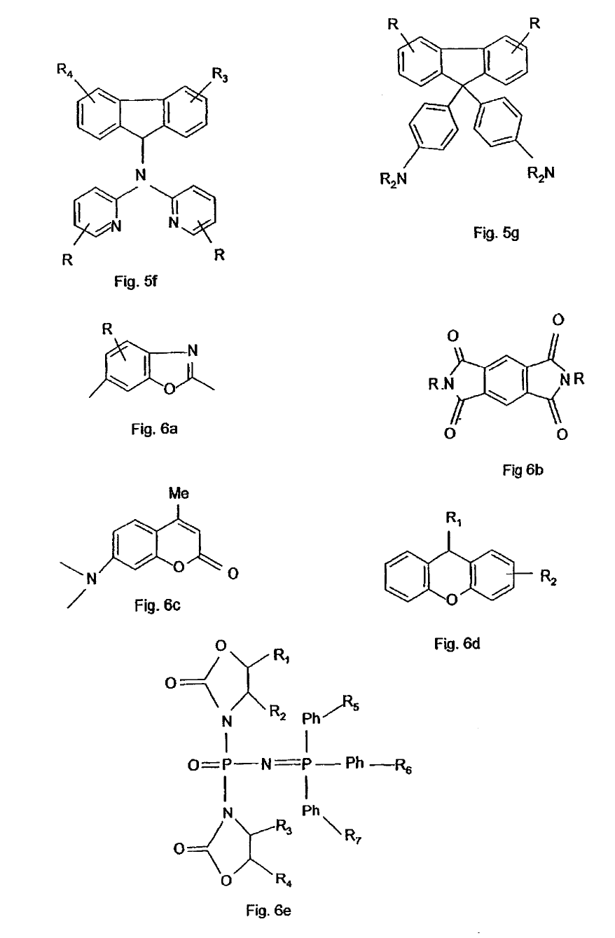

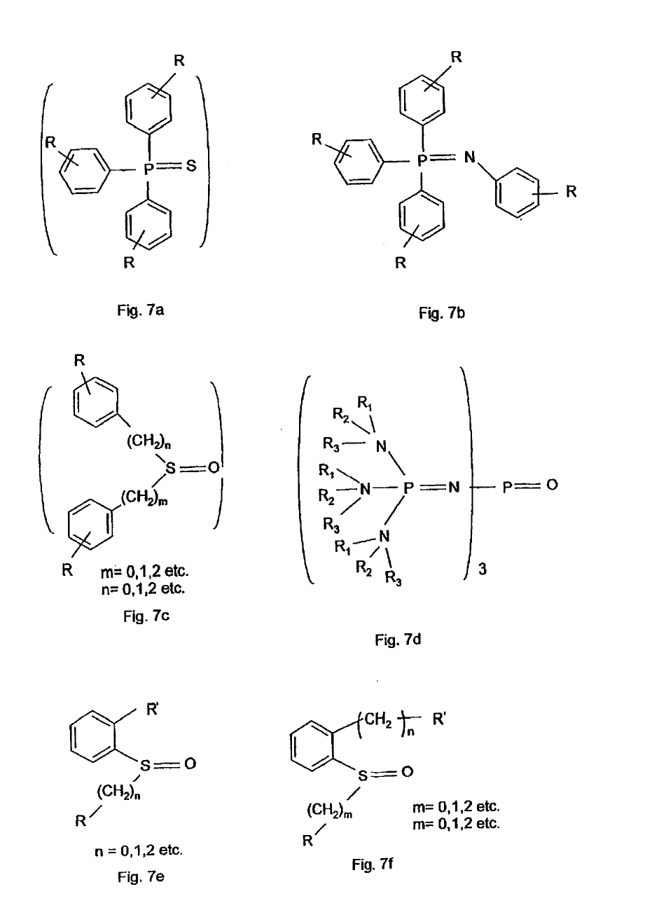

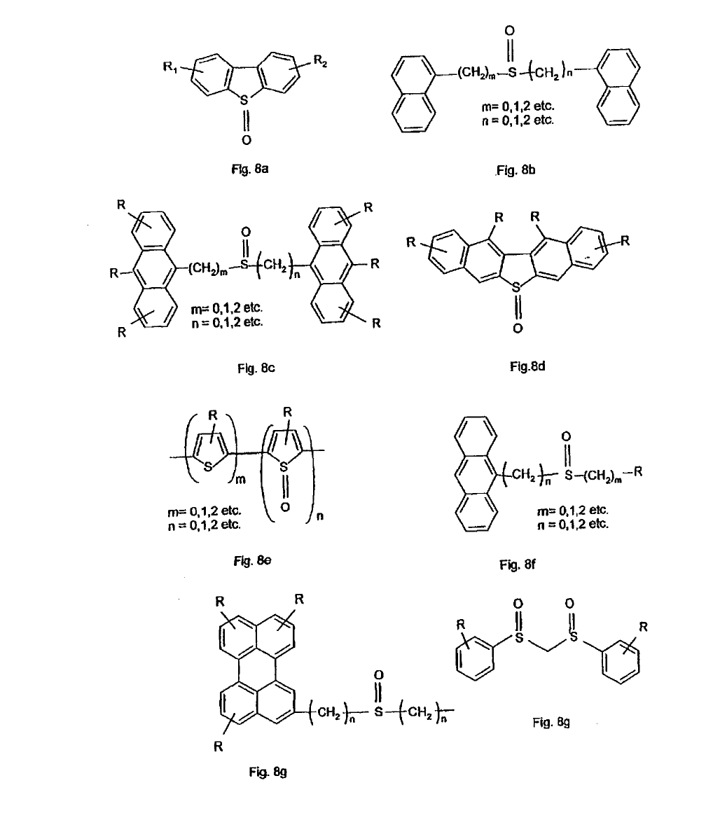

Other examples of Lₚ chelates are as shown in FIG. 4 and fluorene and fluorene derivatives e.g. a shown in FIG. 5 and compounds of formulae as shown as shown in FIGS. 6 to 8.

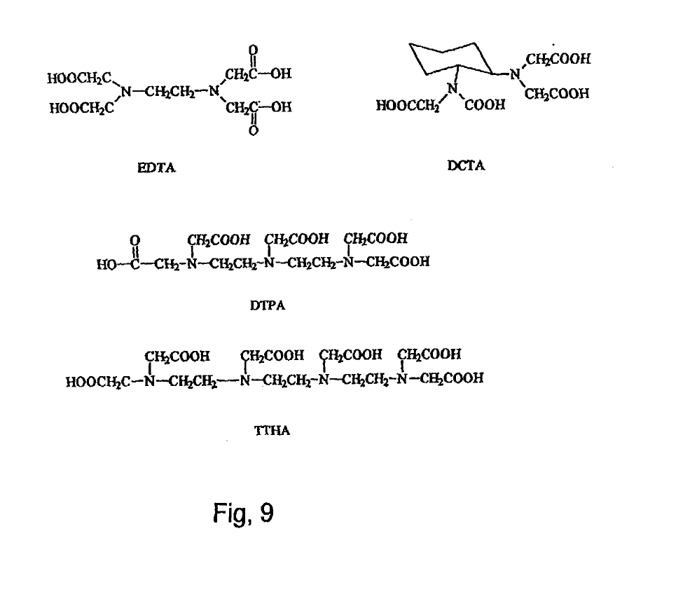

Specific examples of Lα and Lp are tripyridyl and TMHD, and TMHD complexes, α, α′, α″ tripyridyl, crown ethers, cyclans, cryptans phthalocyanans, porphoryins ethylene diamine tetramine (EDTA), DCTA, DTPA and TTHA. Where TMHD is 2,2,6,6-tetramethyl-3,5-heptanedionato and OPNP is diphenylphosphonimide triphenyl phosphorane. The formulae of the polyamines are shown in FIG. 9.

Alternatively the material can be deposited by spin coating from solution or by vacuum deposition from the solid state e.g. by sputtering or any other conventional method can be used.

The electroluminescent material can be deposited on the substrate directly by evaporation from a solution of the material in an organic solvent. The solvent which is used will depend on the material but chlorinated hydrocarbons such as dichloromethane, n-methyl pyrrolidone, dimethyl sulphoxide, tetra hydrofuran dimethylformamide etc. are suitable in many cases.

The first electrode is preferably a transparent substrate such as is a conductive glass or plastic material which acts as the anode, preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate. The electroluminescent material can be deposited on the substrate directly by evaporation from a solution of the material in an organic solvent. The solvent which is used will depend on the material but chlorinated hydrocarbons such as dichloromethane, n-methyl pyrrolidone, dimethyl sulphoxide, tetrahydrofuran dimetlylformamide etc. are suitable in many cases.

Alternatively the material can be deposited by spin coating from solution or by vacuum deposition from the solid state e.g. by sputtering or any other methods can be used.

Optionally the hole transporting material can be mixed with the electroluminescent material and co-deposited with it.

There can be other layers of hole transporting material in addition to the conjugated polymers used in the present invention. These hole tramsporting materials can be used as a buffer layer between the electrode and the conjugated polymer hole transporting materials used in the present invention.

Examples of such hole transporting materials are aromatic amine complexes such as poly (vinylcarbazole), N, N′-diphenyl-N, N′-bis (3-methylphenyl)-1,1′-biphenyl-4,4′-diamine (TPD), an unsubstituted or substituted polymer of an amino substituted aromatic compound, a polyaniline, substituted polyanilines, polythiophenes, substituted polythiophenes, polysilanes etc. Examples of polyanilines are polymers of

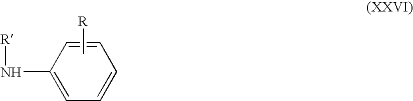

where R is in the ortho- or meta-position and is hydrogen, C1-18 alkyl, C1-6 alkoxy, amino, chloro, bromo, hydroxy or the group

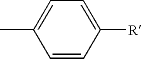

where R is ally or aryl and R′ is hydrogen, C1-6 allyl or aryl with at least one other monomer of formula I above.

Polyanilines which can be used in the present invention have the general formula

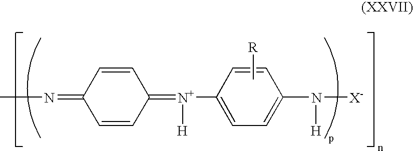

where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate, an example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated, however we have surprisingly found that if the unsubstituted or substituted polymer of an amino substituted aromatic compound is deprotonated the it can be easily evaporated i.e. the polymer is evaporable.

Preferably evaporable deprotonated polymers of unsubstituted or substituted polymer of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F. Epstein, Faraday Discussions, Chem Soc. 88 P319 1989.

The conductivity of the polyaniline is dependant on the degree of protonation with the maximum conductivity being when the degree of protonation is between 40 and 60% e.g. about 50% for example.

Preferably the polymer is substantially fully deprotonated.

A polyaniline can be formed of octamer units i.e. p is four e.g.

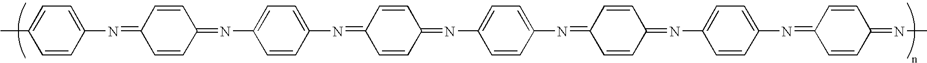

The polyanilines can have conductivities of the order of 1×10⁻¹ Siemen cm⁻¹ or higher.

The aromatic rings can be unsubstituted or substituted e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an ammo substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted e.g. by a group R as defined above.

The polyanilines can be deposited on the first electrode by conventional methods e.g. by vacuum evaporation, spin coating, chemical deposition, direct electrodeposition etc. preferably the thickness of the polyaniline layer is such that the layer is conductive and transparent and can is preferably from 20 nm to 200 nm. The polyanilines can be doped or undoped, when they are doped they can be dissolved in a solvent and deposited as a film, when they are undoped they are solids and can be deposited by vacuum evaporation i.e. by sublimation.

The polymers of an amino substituted aromatic compound such as polyanilines referred to above can also be used as buffer layers with or in conjunction with other hole transporting materials.

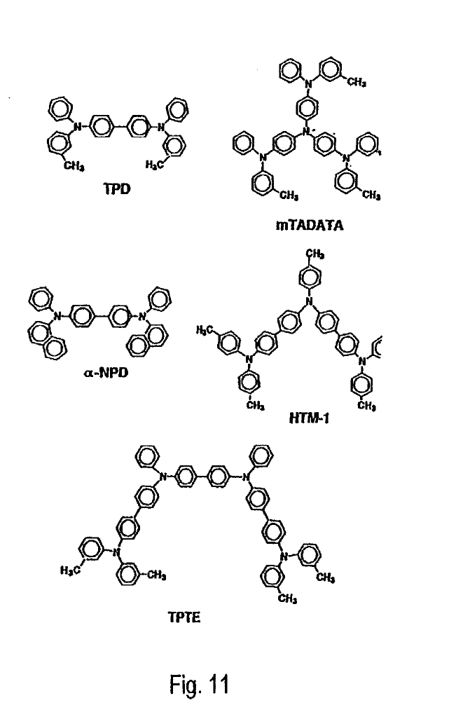

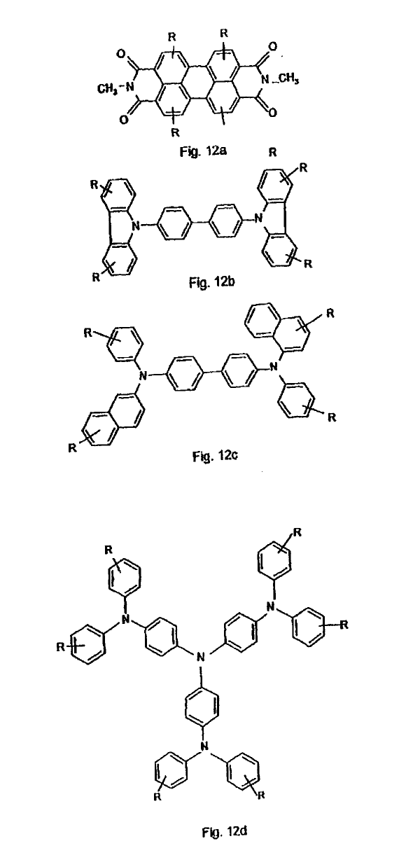

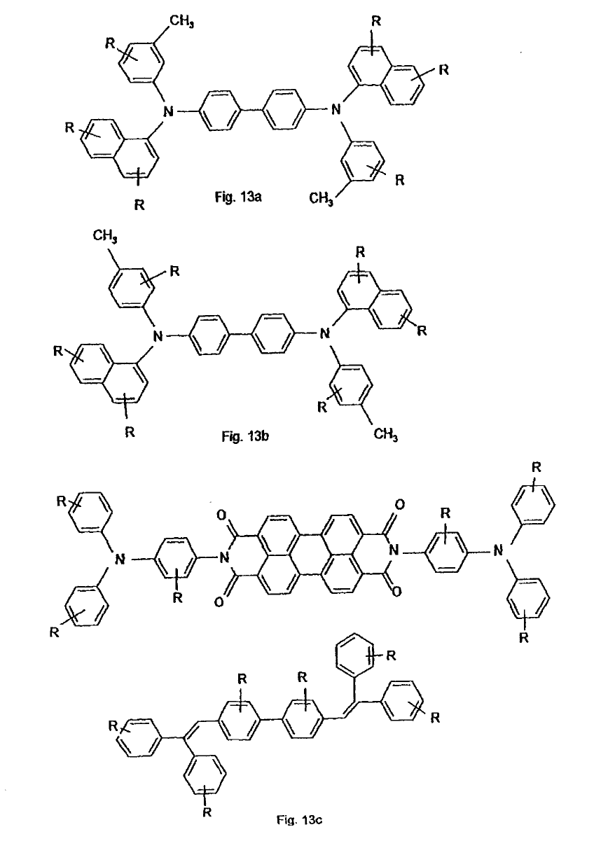

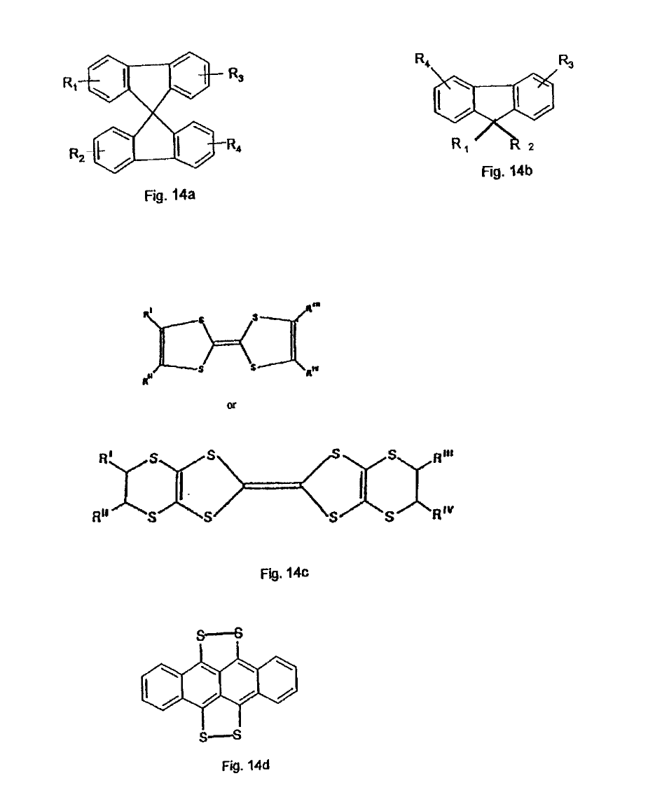

The structural formulae of some other hole transmitting materials are shown in FIGS. 11, 12, 13 and 14 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrite.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

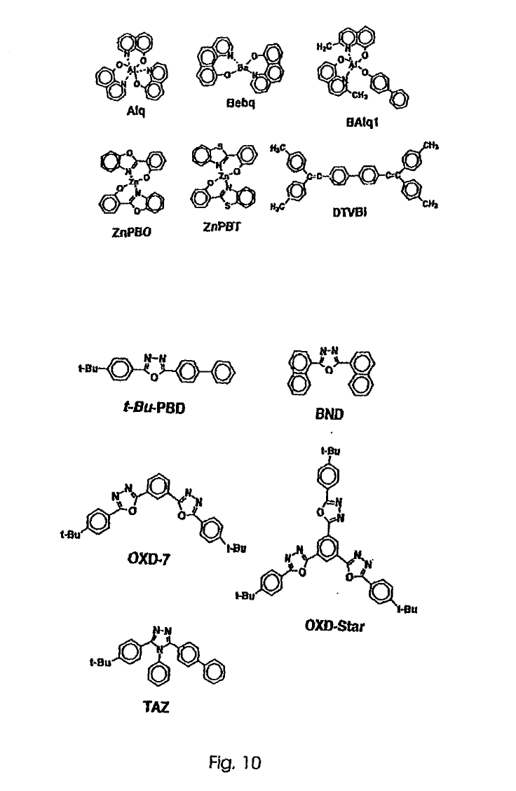

Optionally there is a layer of an electron injecting material between the cathode and the electroluminescent material layer, the electron injecting material is a material which will transport electrons when an electric current is passed through electron injecting materials include a metal complex such as a metal quinolate e.g. an aluminium quinolate, lithium quinolate, a cyano anthracene such as 9, 10 dicyano anthracene, cyano substituted aromatic compounds, tetracyanoquinidodimethane a polystyrene sulphonate or a compound with the structural formulae shown in FIG. 10 of the drawings in which the phenyl rings can be substituted with substituents R as defined above. Instead of being a separate layer the electron injecting material can be mixed with the electroluminescent material and co-deposited with it.

The hole transporting materials, the electroluminescent material and the electron injecting materials can be mixed together to form one layer, which simplifies the construction.

The second electrode functions as the cathode and can be any low work function metal e.g. aluminium, calcium, lithium, silver/magnesium alloys, rare earth metal alloys etc., aluminium is a preferred metal. A metal fluoride such as an alkali metal, rare earth metal or their alloys can be used as the second electrode for example by having a metal fluoride layer formed on a metal.

The display of the invention may be monochromatic or polychromatic. Electroluminescent rare earth chelate compounds are known which will emit a range of colours e.g. red, green, and blue light and white light and examples are disclosed in Patent Applications WO98/58037 PCT/GB98/01773, PCT/GB99/03619, PCT/GB99/04030, PCT/GB99/04024, PCT/GB99104028, PCT/GB00/00268 and can be used to form OLEDs emitting those colours. Thus, a full colour display can be formed by arranging three individual backplanes, each emitting a different primary monochrome colour, on different sides of an optical system, from another side of which a combined colour image can be viewed. Alternatively, rare earth chelate electroluminescent compounds emitting different colours can be fabricated so that adjacent diode pixels in groups of three neighbouring pixels produce red, green and blue light. In a further alterative, field sequential colour filters can be fitted to a white light emitting display.

Either or both electrodes can be formed of silicon and the electroluminescent material and intervening layers of a hole transporting and electron transporting materials can be formed as pixels on the silicon substrate. Preferably each pixel comprises at least one layer of a rare earth chelate electroluminescent material and an (at least semi-) transparent electrode in contact with the organic layer on a side thereof remote from the substrate.

Preferably, the substrate is of crystalline silicon and the surface of the substrate may be polished or smoothed to produce a flat surface prior to the deposition of electrode, or electroluminescent compound. Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode the cathode can be formed of a transparent electrode which has a suitable work function, for example by a indium zinc oxide coated glass in which the indium zinc oxide has a low work function. The anode can have a transparent coating of a metal formed on it to give a suitable work function. These devices are sometimes referred to as top emitting devices or back emitting devices.

The metal electrode may consist of a plurality of metal layers, for example a higher work function metal such as aluminium deposited on the substrate and a lower work function metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

As described in WO00/60669 the brightness of light emitted from each pixel is preferably controllable in an analogue manner by adjusting the voltage or current applied by the matrix circuitry or by inputting a digital signal which is converted to an analogue signal in each pixel circuit. The substrate preferably also provides data drivers, data converters and scan drivers for processing information to address the array of pixels so as to create images. When an electroluminescent material is used which emits light of a different colour depending on the applied voltage the colour of each pixel can be controlled by the matrix circuitry.

In one embodiment, each pixel is controlled by a switch comprising a voltage controlled element and a variable resistance element, both of which are conveniently formed by metal-oxide-semiconductor field effect transistors (MOSFETs) or by an active matrix transistor.

The invention is further described with reference to the examples.

### EXAMPLE 1

Synthesis of poly(p-phenylene) (PPP) by the Kovacic Method.

A suspension of aluminium chloride (13.3 g, 100 mmol) and copper(II) chloride (6.7 g, 50 mmol) in benzene (21 cm³, 400 mmol) was stirred at 31° C. for 2 hours under nitrogen. Excess 18% hydrochloric acid was added, and the solid product separated from the reaction mixture by vacuum filtration. The solid was washed with boiling water and filtered under vacuum until the filtrate was free from chloride ions. The presence of chloride ions in the filtrate was confirmed by the formation of a white (AgCl) precipitate on AgNO₃ addition. Three boiling water washes (200 cm³) were performed before the filtrate was chloride free. The product was dried under vacuum at 120° C. for 2 hours to give a brown powder (0.52 g, 1.7%), density compressed 1.2 g cm³ DP 9.5 showing it was poly(p-phenylene.

### EXAMPLE 2

Synthesis of Poly(benzonitrile-2,5-diyl) (PPCN)

Poly(benzonitrile-2,5-diyl) was synthesised as per literature with N₂ used in place of Ar. Nickel(II) chloride (0.13 g, 1.00 mmol), triphenylphosphine (2.0 g, 7.6 mmol), and zinc powder (2.0 g, 30.6 mmol) were stirred at 70° C. for 2 hours in DMF (8 cm³) under nitrogen dog which time the solution turned red-brown. A nitrogen purged suspension of 2,5-dichlorobenzonitrile (1.72 g, 10 mmol) in DMF (10 cm³) was added and the solution stirred at 80° C. for 20 hours under nitrogen. The product was refined by refluxing for 2×6 hours in 2M hydrochloric acid (300 cm³), ethanol (300 cm³), toluene (300 cm³), chloroform (300 cm³), saturated EDTA solution (pH 9, 300 cm³), saturated EDTA solution with aqueous ammonia (pH 3.8, 300 cm³). Soxhlet extraction was performed for 6 hours in chloroform (300 cm³). The yellow/green powder obtained was dried under vacuum at 120° C. for 2 hours. Found: C, 77.16%; H, 3.04%; N, 11.93%; Cl, 4.09%: other, 3.78%, giving a DP of 15. 0.507 g (43.2 % N based), nickel (by dimethyloxime analysis) <250 ppm, zinc (by dithizone analysis) <1 ppm, THF, CH₂Cl₂, and acetonitrile solubility negligible, beeronitzie, and DMSO solubilities around 0.5%. Thermogravimetric analysis gave no indication of the presence of PPh₃ or P(O)Ph₃. Density of PPCN in compressed disc form (0.97 g cm³). JR (KBr): vₘₐₓ/cm⁻¹ 2230 (s), 1600 (m, d), 1470(s), 1440(w), 390 (m), 1260 (mn), 1180 (m), 1120 (w), 1080 (m), 1000 (w), 910 (m), 835 (s), 800 (m), 750 (w), 700 (m), 650 (w).

### EXAMPLE 3

An ITO coated glass piece (1×1 cm² ) had a portion etched out with concentrated hydrochloric acid to remove the ITO and was cleaned and dried. An electroluminescent device was fabricated by sequentially forming on the ITO, by vacuum evaporation, layers comprising:

ITO(100 Ω/sqr)/(PPP 10 mg)G1 (8.5 mg)/PPCN(10 mg)/Al

Where PPP is poly paraphenylene prepared as in example 1, G1 is Tb(TMHD)₃OPNP where TMHD and OPNP are as defined herein PPCN is poly(benzonitrile-2,5-diyl) prepared as in Example 2 and Alq₃ is aluminium quinolate.

The organic coating on the portion which had been etched with the concentrated hydrochloric acid was wiped with a cotton bud. The coated electrodes were stored in a vacuum desiccator over a molecular sieve and phosphorous pentoxide until they were loaded into a vacuum coater (Edwards, 10⁻⁶ torr) and aluminium top contacts made. The active area of the LED's was 0.08 cm by 0.1 cm² the devices were then kept in a vacuum desiccator until the electroluminescence studies were performed.

The ITO electrode was always connected to the positive terminal. The current vs. voltage studies were carried out on a computer controlled Keithly 2400 source meter.

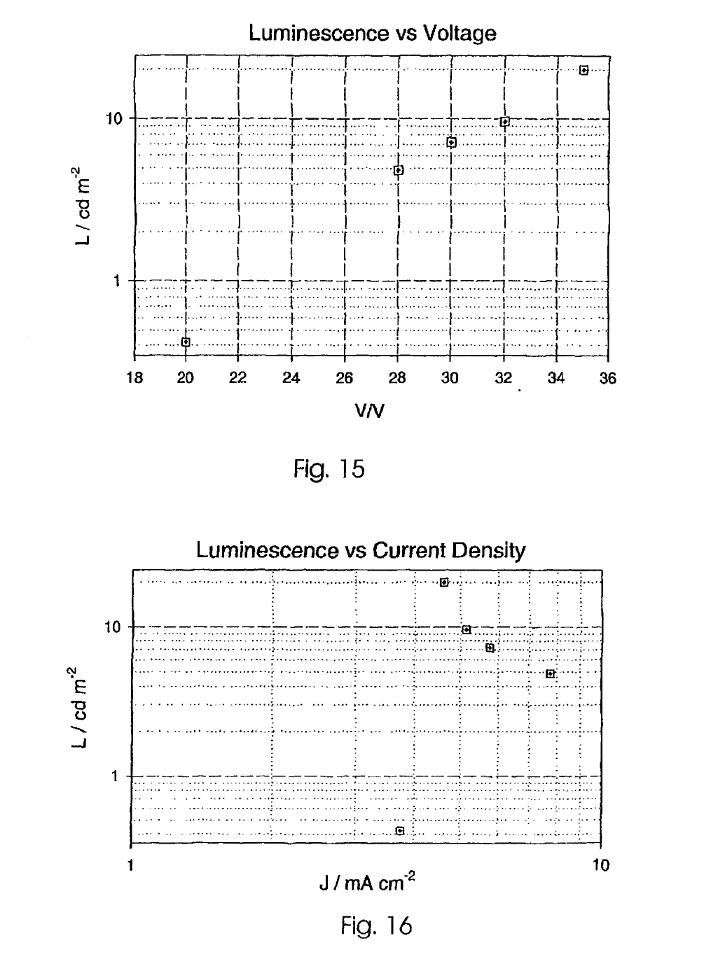

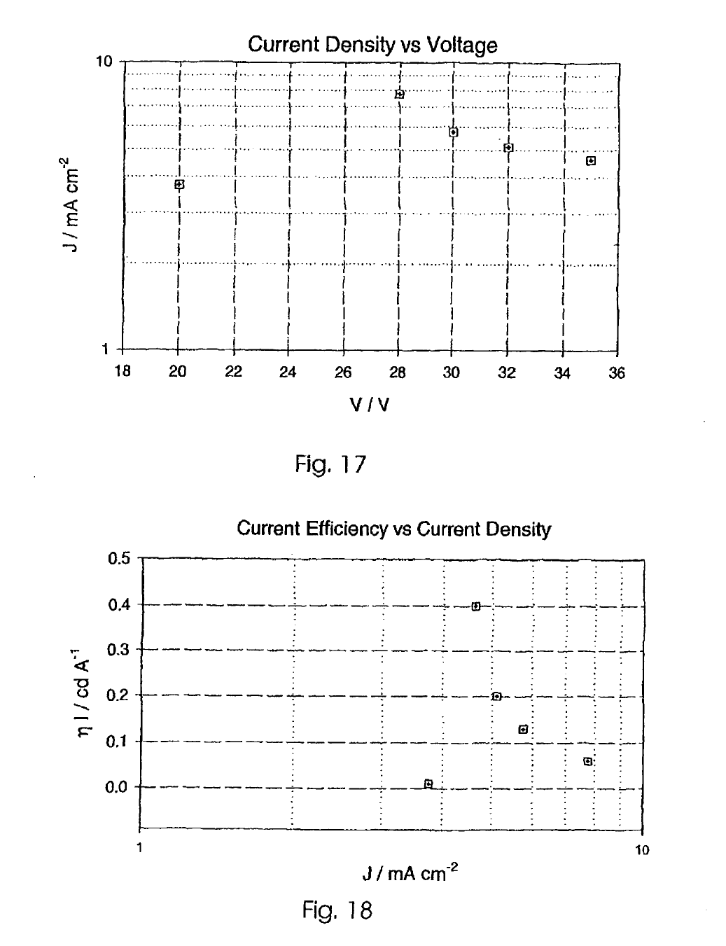

An electric current was applied across the device and light was emitted with a peak wavelength of 548 nm and colour coordinates x=0.32, y=0.61 (CIE Colour Chart 1931) a plot of the luminescence versus voltage is shown in the graph of FIG. 15, a plot of luminescence against current density is shown in FIG. 16, a plot of current density versus voltage is shown in FIG. 17 and a plot of current efficiency against current density shown in FIG. 18.

### EXAMPLE 4

The procedure of example was repeated to form an electroluminescent device comprising

ITO(100 Ω/sqr)/(PPP 10 mg)/Tb (8.5 mg)/(8.5 mg)/Al

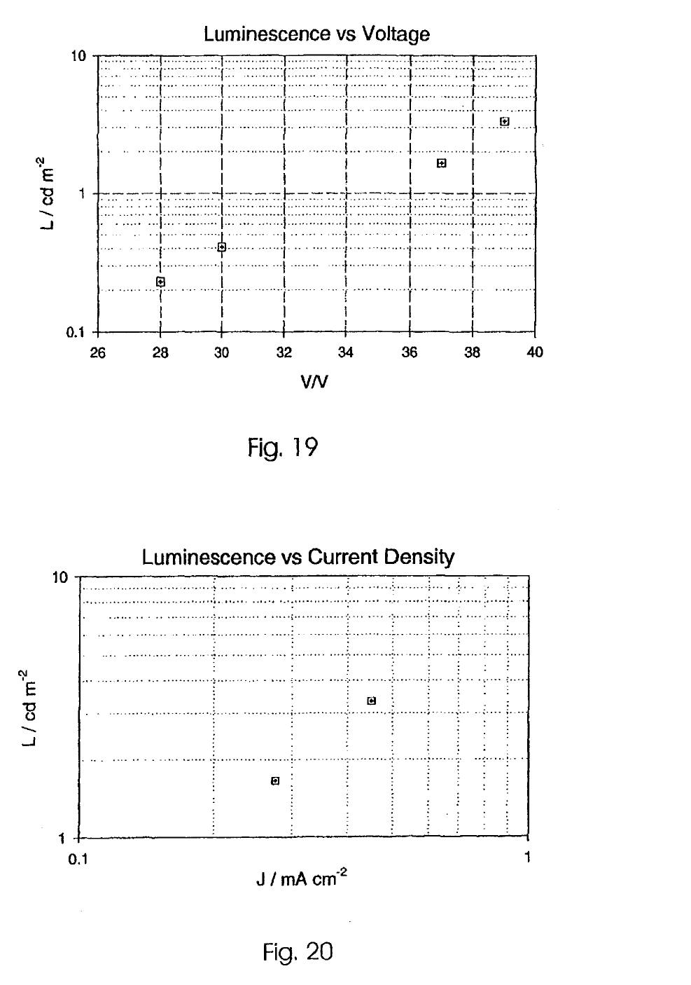

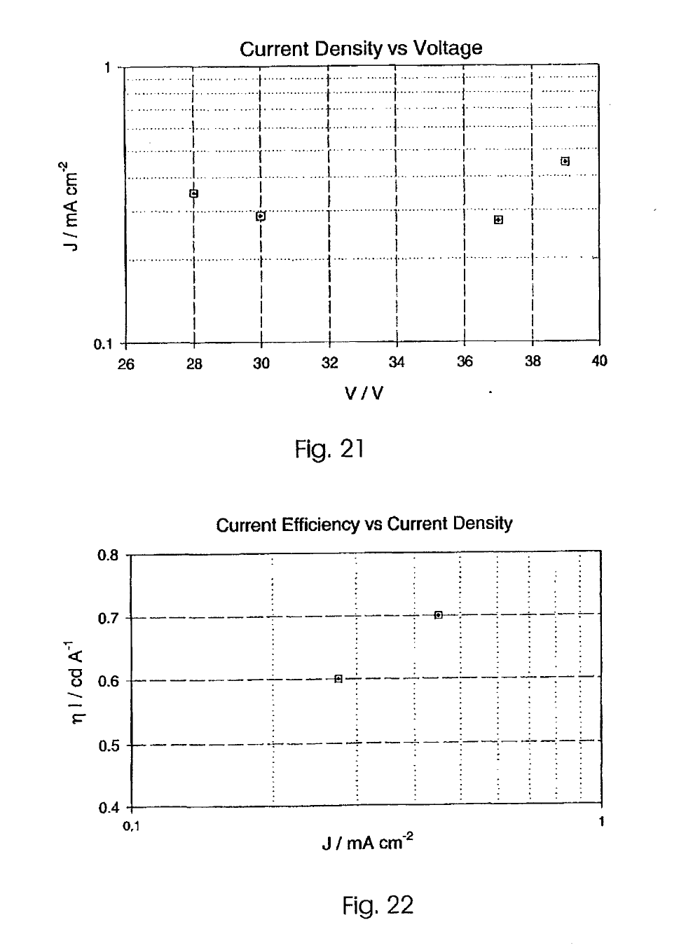

An electric current was applied across the device and light was emitted with a peak wavelength of 548 nm and colour coordinates x=0.32, y=0.61 (CIE Colour Chart 1931) a plot of the luminescence versus voltage is shown in the graph of FIG. 19, a plot of luminescence against current density is shown in FIG. 20, a plot of current density versus voltage is shown in FIG. 21 and a plot of current efficiency against current density shown in FIG. 22.

1. An electroluminescent device comprising (i) a first electrode, (ii) a hole transporting layer formed of a conjugated polymer, (iii) a layer consisting of an electroluminescent material and (iv) a second electrode.

2. An electroluminescent device as claimed in claim 1 in which the conjugated polymers is a poly(arylenevinylene) or a substituted derivative thereof.

3. An electroluminescent device as claimed in claim 2 in which the conjugated polymers is selected from poly(p-phenylenevinylene)-PPV and copolymers including PPV.

4. An electroluminescent device as claimed in claim 3 in which the phenylene ring in PPV carries one or more substituents.

5. An electroluminescent device as claimed in claim 3 in which the phenylene ring in poly(p-phenylenevinylene) is replaced by a fused ring system such as anthracene or naphthlyene ring.

6. An electroluminescent device as claimed in any one of claims 2 to 5 in which the number of vinylene groups in each polyphenylenevinylene moiety is greater than 1.

7. An electroluminescent device as claimed in claim 2 in which the conjugated polymer is selected from poly(2,5 dialkoxyphenylene vinylene), poly (2-methoxy-5-(2-methoxypentyloxy-1,4-phenylenevinylene), poly(2-methoxypentyloxy)-1,4-phenylenevinylene), poly(2-methoxy-5-2-dodecyloxy-1,4-phenylenevinylene) and other poly(2,5 dialkoxyphenylenevinylenes) with at least one of the alkoxy groups being a long chain solubilising alkoxy group.

8. An electroluminescent device as claimed in any one of claims 1 to 7 in which the electroluminescent material has the formula M(Lα)ₙ, where M, is a rare earth metal, a transition metal, lanthanide or an actinide, and Lα is an organic ligand and n is the valence state of M.

9. An electroluminescent device as claimed in any one of the preceding claims in which the electroluminescent material is an organo metallic complex of formula
(Lα)ₙ>M←Lp
where Lα and Lp are organic ligands, M is a rare earth, transition metal, lanthanide or an actinide and n is the valence state of the metal M and in which the ligands Lα are the same or different.

10. An electroluminescent device as claimed in claim 11 in which there are a plurality of ligands Lp which can be the same or different.

11. An electroluminescent device as claimed in claim 2 in which the electroluminescent compound is a complex of formula (Lα)ₙMM₂ where M₂ is a non rare earth metal, Lα is a as above and n is the combined valence state of M and M₂ or the electroluminescent compound is a complex of formula (Lα)ₙMM₂(Lp), where Lp is as above and the metal M₂ is any metal which is not a rare earth, transition metal, lanthanide or an actinide.

12. An electroluminescent device as claimed in any one of the preceding claims in which the electroluminescent material is a binuclear, trinuclear or polynuclear organometallic complex of formula
(Lm)ₓM₁←M₂(Ln)_{y} or 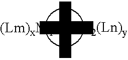
where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂ or
(Lm)ₓM₁-M₃(Ln)_{y}-M₂(Lp)_{z}
or 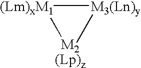
where M₁, M₂ and M₃ are the same or different rare earth metals and Lm, Ln and Lp are organic ligands Lα and x is the valence state of M₁, y is the valence state of M₂ and z is the valence state of M₃ and Lp can be the same as Lm and Ln or different or 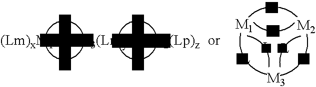
or
M₁-M₂- M₃-M₄
or
M₁-M₂-M₄-M₃
or 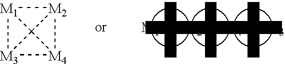
where M₄ is M₁, L is a bridging ligand and in which the rare earth metals and the non rare earth metals can be joined together by a metal to metal bond and/or via an intermediate bridging atom, ligand or molecular group or in which there are more than three metals joined by metal to metal bonds and/or via intermediate ligands.

13. An electroluminescent device as claimed in any one of claims 8 to 12 in which M is selected from Sm(III), Eu(II), Eu(III), Tb(III), Dy(III), Yb(III), Lu(III), Gd(III), Gd(III) U(III), Tm(III), Ce(III), Pr(III), Nd(III), Pm(III), Dy(III), Ho(III) and Er(III).

14. An electroluminescent device as claimed in any one of claims 11 to 13 in which M₂ is selected from lithium, sodium, potassium, rubidium, caesium, beryllium, magnesium, calcium, strontium, barium, copper, silver, gold, zinc, cadmium, boron, aluminium, gallium, indium, germanium, tin, antimony, lead, and metals of the first, second and third groups of transition metals e.g. manganese, iron, ruthenium, osmium, cobalt, nickel, palladium, platinum, cadmium, chromium, titanium, vanadium, zirconium, tantulum, molybdenum, rhodium, iridium, titanium, niobium, scandium and yttrium.

15. An electroluminescent device as claimed in any one of claims 8 to 14 in which Lα has the formula (I) to (XVII) herein.

16. An electroluminescent device as claimed in any one of claims 8 to 15 in which Lp has the formula of FIGS. 1 to 8 of the accompanying drawings or of formula (XVIII) to (XXV) herein.

17. An electroluminescent device comprising (i) a first electrode, (ii) a hole transporting layer formed of a first hole transporting material (iii) a hole transporting layer formed of a second hole transporting material which comprises a conjugated polymer, (iv) a layer consisting of an electroluminescent material and (v) a second electrode.

18. An electroluminescent device as claimed in claim 17 in which the first hole transporting material is an aromatic amine complexes.

19. An electroluminescent device as claimed in claim 17 in which the first hole transporting material is selected from poly (vinylcarbazole), N,N′-diphenyl-N,N′-bis (3-methylphenyl)-1,1′-biphenyl-4,4′-diamine (TPD), an unsubstituted or substituted polymer of an amino substituted aromatic compound, a polyaniline, substituted polyanilines, polythiophenes, substituted polythiophenes and polysilanes.

20. An electroluminescent device as claimed in claim 19 in which the first hole transporting material is a polyaniline of formula XXVI or XVII.

21. An electroluminescent device as claimed in any one of the preceding claims in which there is a layer of an electron injecting material between the cathode and the electroluminescent material layer.

22. An electroluminescent device as claimed in claim 21 in which the electron injecting material is selected from metal quinolates, a cyano-anthracene, 9,10 dicyano-anthracene, a polystyrene-sulphonate, aluminium quinolate and lithium quinolate or has the formula of FIG. 10 of the drawings.

23. An electroluminescent device as claimed in any one of the preceding claims in which the second electrode is aluminium, calcium, lithium, or a silver/magnesium alloys.
